(19) United States
(12) Patent Application Publication
(10) Pub. No.: US 2002/0163715 A1
(43) Pub. Date: Nov. 7, 2002

(54) Microscope, and method for operating a microscope

(75) Inventors: Johann Engelhardt, Bad Schoenborn (DE); Juergen Hoffmann, Bad-Camberg (DE)

Correspondence Address: SIMPSON & SIMPSON, PLLC, 5555 MAIN STREET, WILLIAMSVILLE, NY, 14221-5406, US

(73) Assignee: Leica Microsystems Heidelberg GmbH, Mannheim (DE)

(21) Appl. No.: 10/135,147

(22) Filed: Apr. 30, 2002

(30) Foreign Application Priority Data
May 4, 2001 (DE) 10121732.3

(51) Int. Cl. G02B 21/00; G02B 21/06; G01V 8/00; G01N 21/86

(52) U.S. Cl. 359/368; 359/379; 359/381; 359/388

(57) ABSTRACT

The present invention concerns a microscope and a method for operating a microscope, in particular a confocal or double confocal scanning microscope, having an optical beam path (9) extending between a light source (1), a specimen (2), and a detector (7) and/or a detection optical system, in which context intentional and unintentional relative motions occur between the specimen (2) and the optical beam path (9), undesired relative motions of the microscope components in optical beam path (9) are intended to result in no (or only minor) image defects, and method steps are provided which eliminate or minimize the image defects brought about by undesired relative motions between the specimen (2) and optical beam path (9); and is characterized in that a first device (8) detects relative motions; and a second device (22) compensates for unintentional relative motions.

### CROSS REFERENCE TO RELATED APPLICATIONS

This invention claims priority of the German patent application 101 21 732.3, filed on May 4, 2001, which is incorporated by reference herein.

### FIELD OF THE INVENTION

The present invention concerns a microscope and a method for operating a microscope, in particular a confocal or double confocal scanning microscope, having an optical beam path extending between a light source, a specimen, and a detector and/or a detection optical system, in which context intentional and unintentional relative motions occur between the specimen and the optical beam path.

### BACKGROUND OF THE INVENTION

Microscopes are devices for the examination of microscopic specimens; they are used in many different ways and have become indispensable in the laboratory. Microscopes serve, for example, for the examination of biological and clinical specimens. Confocal or double confocal scanning microscopes have been known for a long time from practical use and research laboratories. Merely by way of example, reference is made to EP 0 491 289 B 1, which discloses a double confocal scanning microscope.

In both conventional and confocal or double confocal scanning microscopy, undesired relative motions between the specimen and the optical beam path result in image defects. These relative motions are displacements of individual microscope components with respect to one another, brought about e.g. by vibrations or by changes in temperature. Vibrations usually cause rapid relative motions; they are induced, for example, by ventilation fans of power supplies. Temperature changes cause longitudinal expansions of individual components, usually resulting in slow relative motions between the specimen and optical beam path. One example thereof that may be mentioned is a laser light source built into the stand of a confocal scanning microscope which, after an extended operating period, heats up the microscope stand; this induces a longitudinal expansion of the microscope stand, thereby resulting in a relative motion between the specimen and the objective that can make long exposures impossible.

Unintentional relative motions can also result from the interaction of a user with the microscope, for example when the user actuates a beam splitter slider to switch over to a different microscope mode.

In confocal or double confocal scanning microscopy in particular, mechanical oscillations or vibrations of a microscope component along the optical axis are a particularly significant source of defects. For example, if the period of such a vibration is of the same order of magnitude as the characteristic times resulting from the pixel scanning rate and line scanning rate, a scan of a specimen surface can become almost unusable, since in this situation a relative motion of the specimen relative to the focal plane of the objective causes serious fluctuations in the detected light power level, which are expressed as striped patterns in the image. In conventional microscope arrangements and when microscopes are operated in routine fashion under laboratory conditions, unintentional relative motions of the specimen are generally very difficult to avoid, since compromises must be made in design terms with regard to mechanical stability and the flexibility with which microscopes can be used.

A low-frequency disturbance, for example resulting from interaction with the microscope user, is difficult to damp because even special mounting techniques either are insufficiently effective or are expensive and complex in terms of equipment. For example, a low-frequency disturbance can be damped using an air bearing for the entire microscope, but the reverberation time of the microscope is usually too long.

Intentional relative motions between the specimen and optical beam path include, for example, focusing of a specimen or motor-controlled specimen positioning in an automatic microscope.

### SUMMARY OF THE INVENTION

It is therefore the object of the present invention to disclose a microscope in which undesired relative motions between microscope components or between microscope components and the specimen result in no or minor image defects.

The object is achieved by a microscope comprising:

microscope components defining a beam path, whereby the microscope components consist at least of a light source for illuminating a specimen, an objective and a specimen stage,

a first device for detecting relative motions between the microscope components and

a second device for compensating for unintentional relative motions.

It is an other object of the present invention to disclose a scanning confocal microscope which avoids or at least minimizes the disturbing effects of undesired changes in the optical beam path.

The aforesaid object is achieved by a scanning confocal microscope comprising:

microscope components defining a beam path, whereby the microscope components consist at least of a light source for illuminating a specimen, an objective and a specimen stage,

a first device for detecting relative motions between the microscope components and

a second device for compensating for unintentional relative motions.

A further object of the present invention is to describe a method for operating a microscope, in particular a confocal or double confocal scanning microscope, in which prevents or minimizes image defects brought about by undesired relative motions between microscope components or between microscope components and the specimen.

The aforesaid object is achieved by a method comprising the steps of:

detecting unintentional relative motions between microscope components with a first device, whereby the microscope components consist at least of a light source for illuminating a specimen, an objective and a specimen stage,

compensating for unintentional relative motions with a second device.

In this context, provision can be made that the device for detecting relative motions is also used to compensate for unintentional relative motions, i.e. that the devices are one and the same. Very generally, however, a device for detecting relative motions and a further device for compensating for unintentional relative motions are provided.

What has been recognized according to the present invention is firstly that the implementation of measures for preventing unintentional relative motions between specimen and optical beam path is fundamentally complex and expensive. For example, a more stable construction of the microscope stage might possibly prevent unintentional relative motions between the specimen and optical beam path, but the complexity necessary for the purpose would be very great, and the microscope modified in that fashion would in some circumstances exhibit less flexibility.

The present invention accordingly does not attempt exclusively to prevent the unintentional relative motions between specimen and optical beam path; instead, provision is made for compensating for the unintentional relative motions. For that purpose, a device detects relative motions between the specimen and the optical beam path of the microscope. If the relative motion detected is an unintentional relative motion, the latter is compensated for by a suitable device. Active or passive components could be provided for this purpose, and (depending on which components of the microscope are provided for compensation) can be implemented in space-saving, simple, and economical fashion on the microscope. Particularly advantageously, this procedure makes possible retrofitting of microscope systems that are already in use. This would not be possible with the approach of trying always to prevent the unintentional relative motions, since the “stable” microscope stand can be exchanged only with great effort for the already existing “unstable” microscope stand.

Since it is not possible to detect directly the relative motion between a specimen and the optical beam path of the microscope, provision is made for the device to detect relative motions

between a specimen and an objective, and/or

between a specimen stage and an objective, and/or

between an objective and a specimen carrier unit, for example a specimen slide or a cover glass, and/or

between a specimen stage and a microscope stand.

The “optical beam path” of the microscope is to be understood in this context as the optical axis of the microscope optical system.

In a confocal or double confocal scanning microscope, a device could be provided that optically detects the relative motions between a specimen and the objective. For this purpose, there could be attached to the specimen, for example, an artificial test specimen, e.g. in the form of a fluorescent latex bead, whose position is detected photooptically using light of a wavelength that is utilized only for that purpose.

The aforementioned specimen carrier unit could be, for example, a specimen slide having a cover glass, the specimen being arranged between the specimen slide and cover glass. In addition, two cover glasses could form a specimen carrier unit, the specimen being arranged between the two cover glasses. A specimen carrier unit configured in this fashion is preferably used in double confocal scanning microscopy. A specimen carrier unit could also be a Petri dish that is adaptable to a microscope stage and allows the examination of living biological specimens.

The device for detecting relative motions comprises one or more sensors that operate mechanically, inductively, capacitatively, photooptically, and/or according to the eddy current sensor principle. For example, inductively or capacitatively operating sensors that detect relative motions between the specimen stage and microscope stand could be provided. Capacitatively operating sensors generally make possible detection with very high spatial resolution.

Alternatively or additionally, the device for detecting relative motions could comprise a photooptical interference arrangement. This serves in particular to measure the distance between two components, for example the specimen stage and microscope stand. This, too, makes possible a distance measurement with very high spatial resolution.

In a concrete embodiment, the device comprises mechanical feelers that are embodied, for example, in the form of thin, hair-like flexural sensors. These mechanical feelers could be arranged, for example, between the objective and the specimen carrier unit or between the specimen stage and objective. The changes in a mechanical feeler could, for example, be detected photooptically, thereby once again making possible a determination of relative motions with high spatial resolution.

In a concrete embodiment, it is provided that the device comprises a lever arrangement. With the lever arrangement, a relative motion of, for example, the specimen carrier unit can be on the one hand directed to a sensor and on the other hand increased in its deflection by mechanical multiplication. The use of a lever arrangement is provided in particular when the device detects relative motions between the specimen carrier unit and the objective or microscope stand, since in the immediate vicinity of a specimen carrier unit (for example a cover glass) there is usually insufficient space to apply corresponding sensors for detecting relative motions. In a concrete embodiment, provision is thus made on the one hand for the lever of the lever arrangement to engage or be attachable onto the specimen carrier unit, for example with a small suction cup or an adhesive coating, and on the other hand for the lever to be mounted on the microscope stand. The lever could be mounted in such a way that it detects relative motions that extend principally along the optical axis of the optical beam path or relative motions perpendicular thereto, i.e. relative motions that extend in a plane oriented parallel to the focal plane of the objective.

In a particularly preferred embodiment, provision is made for unintentional relative motions between the specimen and optical beam path to be compensated for by means of a control system or a control loop. In this respect, the device performs the task of a measurement element of the control system or control loop. In principle, provision is made that the specimen motions, or motions of the specimen stage, intentionally made by a microscope control unit are also detected by the device and—because they are intentional—are not compensated for. For that purpose, the control system or control loop is directly or indirectly connected to a microscope control unit, for example of a confocal scanning microscope.

Unintentional relative motions, on the other hand, are compensated for by means of an adjusting element of the control system or control loop. In this context, the adjusting element could modify the position of the specimen stage and/or of the revolving objective nosepiece and/or of the objective. The modification in position could be accomplished in a manner driven by a piezoelement, galvanometer, or motor. In particular, the position of the objective along its optical axis could be modified by way of a piezo focusing device that can be arranged between the revolving objective nosepiece and the objective. The revolving objective nosepiece could furthermore be displaced in motor-driven fashion along the optical beam path of the microscope. For this purpose, provision is made in particularly preferred fashion to use a motor-driven lever arrangement such as is known, for example, from DE 199 24 709. In addition, an adjusting element could be provided that displaces the position of the specimen stage in the direction of the optical beam path and/or perpendicular thereto. For positioning of the specimen stage along the optical beam path of the microscope, provision is preferably made for using an arrangement such as is known, for example, from DE 196 50 392.

In a further preferred embodiment, provision is made for a shift and/or tilt of an optical component in the beam path of the microscope to be accomplished in order to compensate for unintentional relative motions. A lens element or a mirror could be provided, for example, as the optical component for compensating for unintentional relative motions. The optical component could be shifted axially (i.e. along the optical beam path of the microscope) or laterally (i.e. transversely thereto). Alternatively or in addition thereto, provision is made for a tilt of the optical components, which preferably is executed about two tilt axes perpendicular to one another; this can be achieved, for example, using a universal-joint arrangement. In particularly advantageous fashion, this type of compensation can be accomplished very quickly, since the optical component can be moved quickly because of its low mass.

If the microscope is a confocal or double confocal scanning microscope, provision is made, in order to compensate for an unintentional relative motion of the specimen in the lateral direction, for modulating a correction signal onto the control signals of the scanning device of the scanning microscope. It is thereby possible—at least within a certain range that depends on the properties of the scanning device and the imaging optical system—to compensate for an unintentional relative motion of the specimen in the lateral direction by the fact that with corresponding “offset signals,” the scanning device now performs the scanning operation not at the original point, but rather at the point at which the specimen is located after the relative motion. This compensation as well can, advantageously, be performed very quickly.

The features so far described for compensating for unintentional relative motions of the specimen can preferably be supported using actively controlled mechanisms for vibration suppression and/or vibration compensation. For example, provision is made for the microscope stand and/or specimen stage and/or revolving objective nosepiece and/or objective to be equipped with an actively controlled mechanism for vibration suppression and/or vibration compensation. An actively controlled pendulum and/or actively controlled antiroll tanks could be provided, for example, as active controlled mechanisms. Such tanks are known from the field of shipbuilding, in which rolling of a ship when waves are encountered is suppressed by the actively controlled antiroll tanks. Low-frequency vibrations, in particular, can be damped or suppressed with the actively controlled mechanisms for vibration suppression or vibration compensation.

In particularly advantageous fashion, a microscope according to the present invention could also be used to compensate for unintentional relative motions that are attributable to an interaction of a user with the microscope. A user interaction could comprise, for example, an objective change (i.e. swinging in a different objective by actuation of the revolving objective nosepiece), a filter change, and/or a beam switchover. Such user interactions usually result in an unintentional relative motion, albeit a small one, between the specimen and optical beam path, which can be compensated for in the context of the microscope according to the present invention.

The method according to the present invention for operating a microscope could preferably be performed with a microscope as described above.

### BRIEF DESCRIPTION OF THE DRAWINGS

FIG. 1 is a schematic depiction of a first exemplary embodiment of a microscope according to the present invention; and

FIG. 2 is a schematic depiction of a further exemplary embodiment of a microscope according to the present invention.

### DETAILED DESCRIPTION OF THE INVENTION

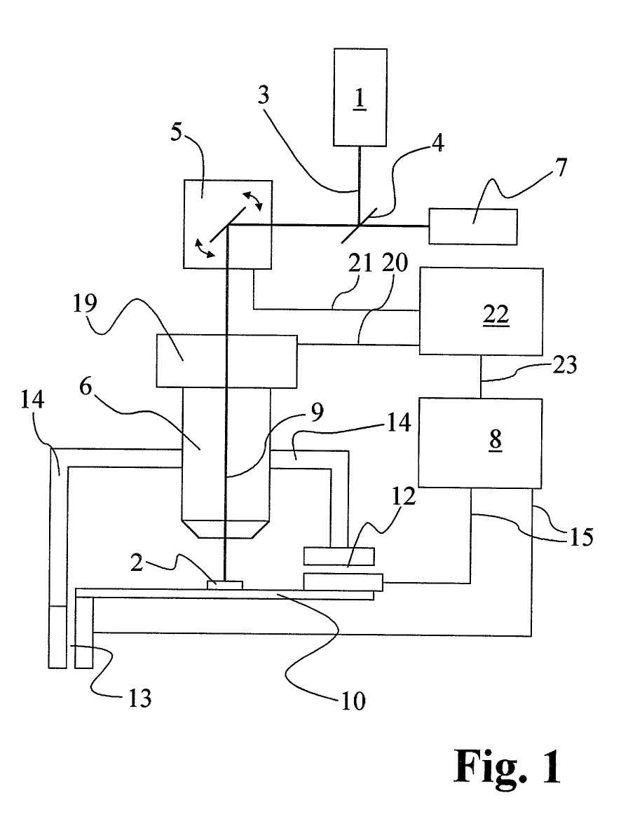

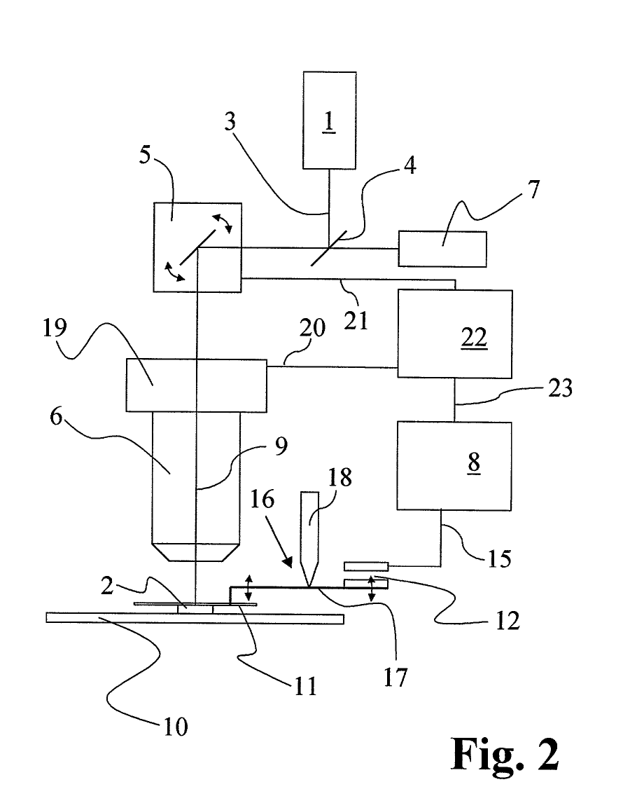

FIGS. 1 and 2 each show a confocal scanning microscope that comprises a light source 1 for illumination of a specimen 2. Light 3 of light source 1 is reflected from main beam splitter 4 to scanning device 5. Scanning device 5 comprises a scanning mirror that is mounted rotatably about two axes arranged perpendicularly to one another. This scanning mirror reflects light 3 of light source 1. By rotation of the scanning mirror, light 3 of light source 1 is deflected appropriately so that after passage through objective 6, specimen 2 can be scanned in point fashion. The induced fluorescent light or reflected light from specimen 2 passes through objective 6 in the opposite direction, is reflected by scanning device 5 to main beam splitter 4, and ultimately can be detected by detector 7.

According to the present invention, the confocal scanning microscope shown in FIG. 1 can comprise a device 8 that detects relative motions between specimen 2 and optical beam path 9 of the microscope. A device 22 compensates for unintentional relative motions between specimen 2 and optical beam path 9.

Device 8 of FIG. 1 detects relative motions between objective 6 and specimen stage 10. In the confocal scanning microscope shown in FIG. 2, device 8 detects relative motions between the microscope stand (not depicted) and cover glass 11, which is part of the specimen carrier unit.

Device 8 comprises sensors 12, 13 that operate capacitatively and serve to determine the positions of the respective components. Sensor 12 of FIG. 1 serves to determine the axial position of specimen stage 10, and sensor 13 serves to determine the lateral position. One part of each sensor 12, 13 is joined via holder 14 to objective 6, so that relative motions between objective 6 and specimen stage 10 are ultimately detectable with sensors 12, 13. Sensors 12, 13 are directly connected to device 8 via lines 15.

FIG. 2 shows a lever arrangement 16 that comprises a mechanical lever 17 and a mount 18 of mechanical lever 17. Mount 18 of lever 17 is secured to the microscope stand (not shown in FIG. 2). Mechanical lever 17 is applied at its one end directly onto cover glass 11. A part of the capacitatively operating sensor 12 is attached to the other end of mechanical lever 17. With lever arrangement 16 shown in FIG. 2 it is thus possible to detect relative motions between cover glass 11 and the microscope stand.

Unintentional relative motions between the specimen and optical beam path are compensated for using a control loop, in which context device 22 operates as the sensor unit of the control loop. Device 8 is connected via line 23 directly to device 22; the data concerning relative motions detected by device 8 are ultimately transferred via line 23 to device 22, which receives and processes those signals. Piezoelement 19 shown in FIGS. 1 and 2, which positions objective 6 in the axial direction, i.e. along optical beam path 9, is provided as the adjusting element of the control loop. For that purpose, piezoelement 19 is connected via line 20 to device 22. [?Compensation for] An unintentional relative motion of specimen 2 in the lateral direction is achieved by modulating a correction signal onto the control signals of scanning device 5, for which purpose scanning device 5 is connected via line 21 to device 22.

In conclusion, be it noted very particularly that the exemplary embodiments discussed above serve merely to describe the teaching claimed, but do not limit it to the exemplary embodiments.

What is claimed is:

1. A microscope comprising:
microscope components defining a beam path, whereby the microscope components consist at least of a light source for illuminating a specimen, an objective and a specimen stage,
a first device for detecting relative motions between the microscope components and
a second device for compensating for unintentional relative motions.

2. The microscope as defined in claim 1, wherein the first device detects relative motions between the specimen and the objective.

3. The microscope as defined in claim 1, wherein the first device detects relative motions between the specimen stage and the objective.

4. The microscope as defined in claim 1, whereby microscope components include a specimen carrier unit and whereby the first device detects relative motions between the objective and the specimen carrier unit.

5. The microscope as defined in claim 1, whereby microscope components include a microscope stand unit and whereby the first device detects relative motions between the objective and the microscope stand.

6. The microscope as defined in claim 1, wherein the first device comprises sensors that operate mechanically, inductively, capacitatively, photooptically, and/or according to the eddy current sensor principle.

7. The microscope as defined in claim 1, wherein the first device comprises a photooptical interference arrangement for distance measurement.

8. The microscope as defined in claim 1, wherein the first device comprises mechanical feelers.

9. The microscope as defined in claim 1, wherein the second device includes a control system or a control loop.

10. The microscope as defined in claim 9, wherein the first device acts as a measurement element of the control system or the control loop.

11. The microscope as defined in claim 9, wherein the second device includes an adjusting element, which is driven by a piezoelement, galvanometer, or motor.

12. The microscope as defined in claim 11, wherein the adjusting element consists at least of one of the microscope components .

13. The microscope as defined in claim 12, wherein the adjusting element is movable or tiltable.

14. A confocal scanning microscope comprising:
microscope components defining a beam path, whereby the microscope components consist at least of a light source for illuminating a specimen, an objective and a specimen stage,
a first device for detecting relative motions between the microscope components and
a second device for compensating for unintentional relative motions.

15. The confocal microscope as defined in claim 14, whereby the confocal microscope is a double confocal scanning microscope.

16. A method for operating a microscope comprising the steps of:
detecting unintentional relative motions between microscope components with a first device, whereby the microscope components consist at least of a light source for illuminating a specimen, an objective and a specimen stage,
compensating for unintentional relative motions with a second device.
